(19) United States
(12) Patent Application Publication
(10) Pub. No.: US 2026/0145460 A1
(43) Pub. Date: May 28, 2026

(54) STENCIL ALIGNMENT APPARATUS USING PLIABLE CORNER GUIDES

(71) Applicant: Effie Cho, Maspeth, NY (US)

(72) Inventor: Effie Cho, Maspeth, NY (US)

(21) Appl. No.: 19/222,931

(22) Filed: May 29, 2025

Related U.S. Application Data
(63) Continuation-in-part of application No. 18/956,570, filed on Nov. 22, 2024, now abandoned.

(51) Int. Cl. B44D 2/00; B43L 12/00

(52) U.S. Cl. CPC B44D 2/007; B43L 12/00

(57) ABSTRACT

The present disclosure relates to a stencil alignment apparatus (100). The apparatus (100) comprising at least one stencil (102). The apparatus (100) also comprising a cardstock (104) placed under the stencil (102) and the cardstock (104) configured to serve as a base material. The apparatus (100) also comprising a grip mat (106) placed under the stencil (102) and the cardstock (104) and the grip mat (106) configured to hold the stencil (102) and the cardstock (104) in place. The apparatus (100) also comprising at least two corner guides (108) placed over the grip mat (106) and the corner guides (108) configured to fix the position of a stencil (102) on the grip mat (106) to aid in the alignment of subsequent stencil (102) or layering stencils (102). The corner guides (108) are placed diametrically or diagonally opposite to each other.

### FIELD OF THE INVENTION

Embodiments of the present invention relate to an apparatus for stencil alignment and specifically relates to an apparatus for stencil alignment using pliable corner guides.

### DESCRIPTION OF THE RELATED ART

Traditionally, crafters have developed and refined numerous techniques to achieve precise and creative results in paper crafting projects, particularly when using stencils. One such method involves using the corner of a piece of cardstock to align the stencils accurately. Any slight misalignment can ruin the design, necessitating a restart or significant adjustments. Therefore, it is essential to ensure that the stencil remains in a fixed position, allowing the crafter to apply inks, paints, or other mediums with confidence that the design will be perfectly aligned.

The alignment of the stencil and cardstock is particularly useful when creating repeating patterns or when multiple stencils need to be used in succession. By aligning the stencil with the corner of the cardstock, crafters can quickly and easily reposition the stencil as needed, ensuring that each application is consistent and precise. To achieve this precision of positioning, crafters typically secure the stencil to the cardstock using temporary adhesive or low-tack tape. This prevents the stencil from shifting during the inking process.

While traditional techniques like aligning stencils with the corner of cardstock using temporary adhesives or low-tack tape to secure stencils offer stability and precision, but are associated with many limitations. The temporary adhesives or low-tack tape, while helpful, can sometimes leave residue or damage the delicate surface of the cardstock, compromising the overall finish. In addition, in highly detailed stencil patterns, the use of adhesives or tapes can increase the risk of ink bleeding under the stencil edges. This can lead to blurry or unclear designs, which detract from the overall aesthetic. Additionally, environmental factors such as humidity and temperature can affect the performance of tapes and adhesives, potentially causing issues with stability or decreased adhesive effectiveness.

Another method for aligning the cardstock to the stencils using acrylic grip, which has an aesthetic appeal due to its clarity and sleek finish. However, despite these visual advantages, acrylic poses significant practical challenges. One major drawback is its brittleness, which makes it product extremely prone to snapping or breaking. This fragility can be particularly problematic during long-term handling and handling of multiple stencils, limiting the durability and longevity. Additionally, the acrylic grip does not adhere well to grip mats. This lack of adhesion complicates the crafting process, as the stencil can shift or slip during crafting, leading to inaccuracies and potential damage to the project.

In a nutshell, as crafting demands precision, creativity, and patience in the use of stencils for creating intricate and vibrant designs on cardstock. Maintaining a stationary stencil during this process is crucial for achieving high-quality results. While grip mats are commonly used to hold stencils in place without tape, they often fall short when the multiple stencils are used in the crafting.

Thus, there is need for a new mechanism for aligning the cardstock to the stencils that can address the aforementioned issues effectively, while retaining aesthetic qualities comparable to acrylic but also significantly enhances durability, reducing the likelihood of breakage. There is need for a solution that can provide precise alignment and stability to sequentially use of stencils on grip mats that can eliminate the need for extra tape and enhance the overall crafting experience.

Therefore, the present invention provides a stencil alignment apparatus using corner guides.

### SUMMARY OF THE INVENTION

Embodiments of the present invention relate to a stencil alignment apparatus. The apparatus comprising at least one stencil. The apparatus also comprising a cardstock placed under the stencil and the cardstock configured to serve as a base material. The apparatus also comprising a grip mat placed under the stencil and the cardstock and the grip mat configured to hold the stencil and the cardstock in place. The apparatus also comprising at least two corner guides placed over the grip mat and the corner guides configured to fix the position of the stencil on the grip mat to aid in the alignment of subsequent stencil or layering stencils. The corner guides are placed diametrically or diagonally opposite to each other.

In accordance with an embodiment of the present invention, the corner guides are made from non-porous and pliable material.

In accordance with an embodiment of the present invention, the corner guides are made from mylar.

In accordance with an embodiment of the present invention, the corner guides are either a square corner guides or a rectangular corner guide.

In accordance with an embodiment of the present invention, the corner guides are adjustable to accommodate varying sizes of different stencil dimensions.

In accordance with an embodiment of the present invention, the corner guides include an adhesive strip along one edge to secure position on the grip mat.

In accordance with an embodiment of the present invention, the corner guides are repositionable without the loss of adhesion on the adhesive strip.

In accordance with an embodiment of the present invention, the corner guides have rounded edges to prevent any injury or discomfort to the user.

In accordance with an embodiment of the present invention, the corner guides are washable to allow for easy cleaning and maintenance.

In accordance with an embodiment of the present invention, the corner guides include a textured surface to enhance grip and prevent slippage.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1A illustrates a block diagram for a stencil alignment apparatus, in accordance with an embodiment of the present invention;

FIG. 1B illustrates a perspective view of an exemplary prototype of the stencil alignment apparatus, in accordance with an embodiment of the present invention;

FIG. 1C illustrates a top view of an exemplary prototype of the stencil alignment apparatus, in accordance with an embodiment of the present invention; and

FIG. 1D illustrates a perspective view an exemplary prototype of the corner guides, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE INVENTION

In the following detailed description, numerous specific details are set forth in order to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### The Following Brief Definition of Terms Shall Apply Throughout the Present Invention

The terms “determining”, “measuring”, “evaluating”, “assessing,” “assaying,” and “analyzing” can be used interchangeably herein to refer to any form of measurement, and include determining if an element is present or not. (e.g., detection). These terms can include both quantitative and/or qualitative determinations. Assessing may be relative or absolute.

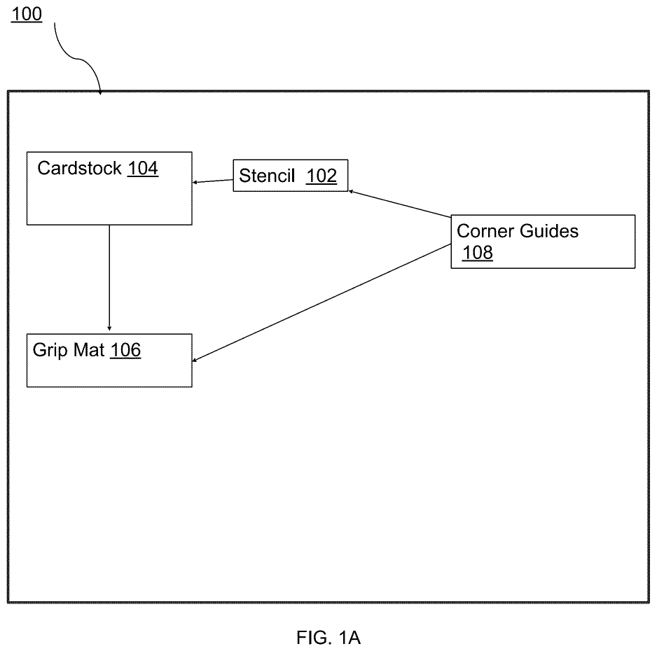

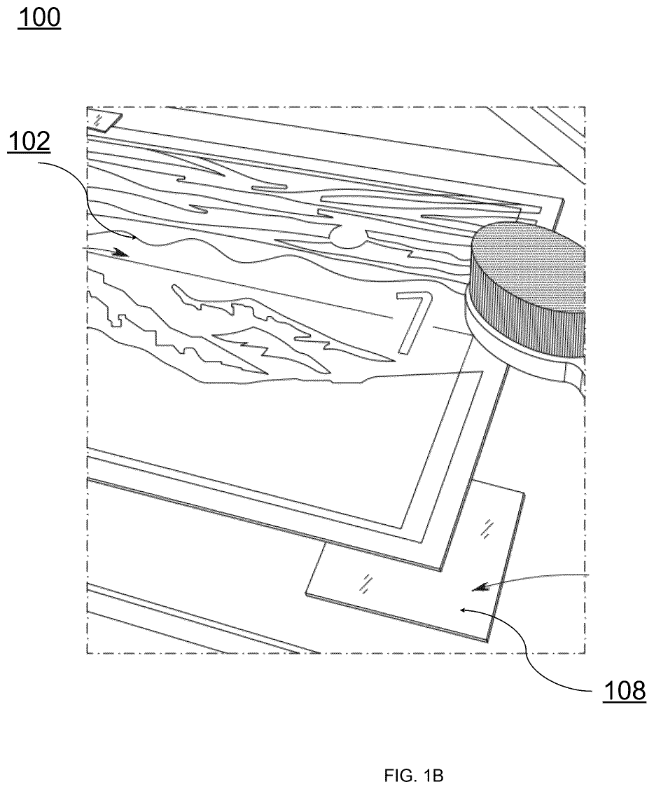

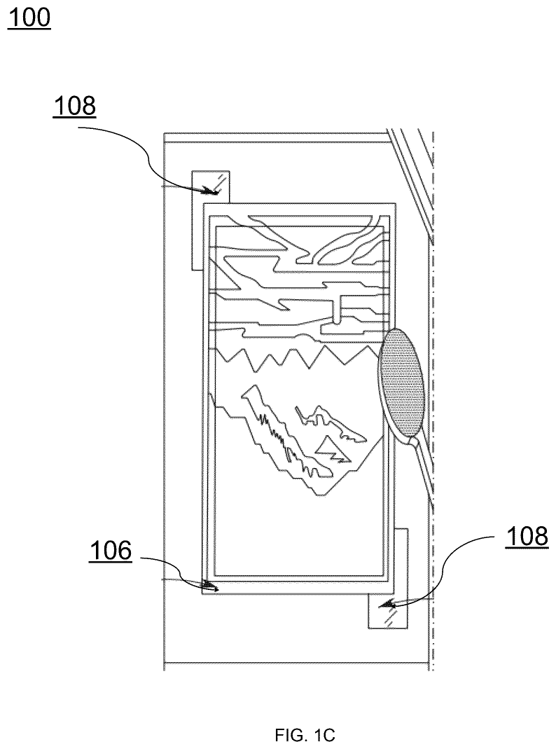

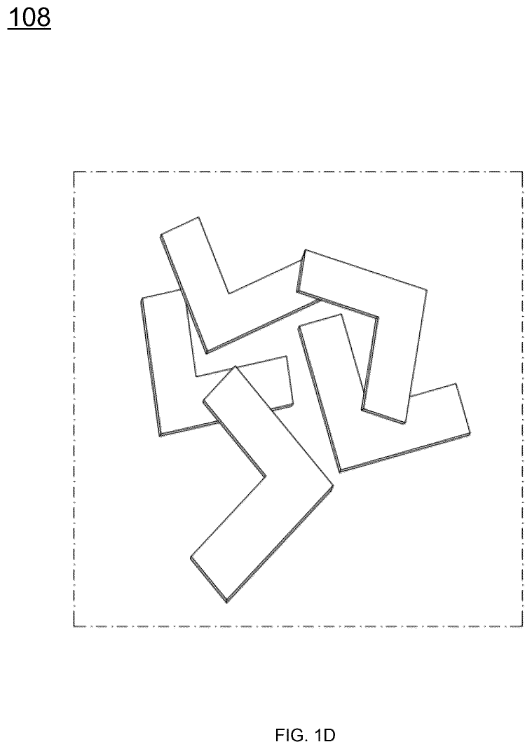

FIG. 1A illustrates a block diagram for a stencil alignment apparatus 100, in accordance with an embodiment of the present invention.

The apparatus 100 may comprise at least one stencil 102, a cardstock 104, a grip mat 106, and at least two corner guides 108.

The cardstock 104 may be placed under the stencil 102 and the cardstock 104 configured to serve as a base material.

The grip mat 106 may be placed under the stencil 102 and the cardstock 104 and the grip mat 106 configured to hold the stencil 102 and the cardstock 104 in place.

The two corner guides 108 may be placed over the grip mat 106 and the corner guides 106 configured to fix the position of the stencil 102 on the grip mat 106 to aid in the alignment of subsequent stencil 102 or layering stencils 102. The corner guides 108 may be placed diametrically or diagonally opposite to each other.

The corner guides 108 may be made from non-porous and pliable material.

The corner guides 108 may be made from mylar.

The corner guides 108 may be either a square corner guides or a rectangular corner guide.

The corner guides 108 may be adjustable to accommodate varying sizes of different stencil dimensions.

The corner guides 108 may include an adhesive strip along one edge to secure position on the grip mat.

The corner guides 108 may be repositionable without the loss of adhesion on the adhesive strip.

The corner guides 108 may have rounded edges to prevent any injury or discomfort to the user.

The corner guides 108 may be washable to allow for easy cleaning and maintenance.

The corner guides 108 may include a textured surface to enhance grip and prevent slippage.

FIG. 1B illustrates a perspective view of an exemplary prototype of the stencil alignment apparatus 100, in accordance with an embodiment of the present invention.

FIG. 1C illustrates a top view of an exemplary prototype of the stencil alignment apparatus 100, in accordance with an embodiment of the present invention.

FIG. 1D illustrates a perspective view an exemplary prototype of the corner guides 108, in accordance with an embodiment of the present invention.

In a preferred embodiment, the corner guides 108 may have the 90° angle to help position the square/rectangular stencils 102. The corner guides 108 is the 90° angle on the inside to guide placement. In some embodiments, the grip mat 106 and the corner guides may be made up of any recyclable or biodegradable materials to align with eco-friendly crafting practices. In some embodiments, the corner guide 108 may have a dual-adhesive mechanism, with a stronger adhesive on one side for attachment to the grip mat 106 and a weaker adhesive on the other side for the stencil 102 placement.

In some embodiments, the corner guides 108 may be color-coded to indicate different positions or orientations for complex stencil layering projects. In some embodiments, the corner guides 108 may include a set of marking indicators on the corner guides to ensure consistent placement.

In some embodiments, the corner guides 108 may be designed to be stackable for storage, reducing space, while maintaining the adhesive properties. In some embodiments, the corner guides 108 may include built-in magnets to provide improved stability and precision. In some embodiments, the corner guides 108 may be made up of heat resistant material that enables enabling use with heat-applied crafting techniques.

In some embodiments, the grip mat 106 may be infused with an anti-slip coating to prevent movement on the work surface. In some embodiments, the grip mat 106 may include a grid pattern to further assist in the precise alignment of stencils. In some embodiments, the stencils 102 may be made up of any suitable material including, but not limited to, mylar. In some embodiments, the cardstock may be any type of base for cards and/or a medium for artistic expression.

The disclosed invention may ensure precise alignment of the stencil 102 and the cardstock 104 using the corner guides 108. The corner guides 108 may ensure that the stencil/s 102 are perfectly aligned, making it easier to achieve accurate and consistent layering in multi-stencil projects. The corner guides 108 made up of mylar material may be durable and may be reused multiple times without losing their effectiveness.

The lightweight and flexible nature of the mylar used for the corner guides 108 may add to the convenience of the crafters.

The corner guides 108 with simple design may allow the user to quickly and easily place and remove the stencils 102. The corner guides 108 may accommodate various sizes for the rectangular and square shaped stencils 102, making the proposed invention suitable for a wide range of crafting projects.

The corner guides 108 with the grip mat 106 may hold the stencil 102 securely in place, reducing the risk of shifting and smudging during use. The proposed invention is low maintenance with easy to clean the grip mat 106 and the corner guides 108. Thereby, the proposed invention may remain in good condition for repeated use.

Additionally, there is no dimension requirement for making the corner guides 108 which is advantageous over acrylic sheet guide that are more prone to napping.

The proposed invention may be cost-effective, by reducing wastage and enhancing long-term use. The proposed invention may save time by simplifying the stencil alignment process. Thus, the proposed invention may improve alignment and stability of the stencil 102, aiding by the crafters in achieving professional-quality results and overall aesthetic of their projects.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. A stencil alignment apparatus, the apparatus comprising:
at least one stencil;
a cardstock placed under the stencil, the cardstock configured to serve as a base material;
a grip mat placed under the stencil and the cardstock, the grip mat configured to hold the stencil and the cardstock in place; and
at least two corner guides placed over the grip mat, the corner guides configured to fix the position of the stencil on the grip mat to aid in the alignment of subsequent stencil or layering stencils,
wherein the corner guides are placed diametrically or diagonally opposite to each other.

2. The apparatus of claim 1, wherein the corner guides are made from non-porous and pliable material.

3. The apparatus of claim 2, wherein the corner guides are made from mylar.

4. The apparatus of claim 1, wherein the corner guides are either a square corner guides or a rectangular corner guide.

5. The apparatus of claim 4, wherein the corner guides are adjustable to accommodate varying sizes of different stencil dimensions.

6. The apparatus of claim 1, wherein the corner guides include an adhesive strip along one edge to secure position on the grip mat.

7. The apparatus of claim 6, wherein the corner guides are repositionable without the loss of adhesion on the adhesive strip.

8. The apparatus of claim 1, wherein the corner guides have rounded edges to prevent any injury or discomfort to the user.

9. The apparatus of claim 1, wherein the corner guides are washable to allow for easy cleaning and maintenance.

10. The apparatus of claim 1, wherein the corner guides include a textured surface to enhance grip and prevent slippage.
